(19) United States
(12) Patent Application Publication
(10) Pub. No.: US 2015/0066788 A1
(43) Pub. Date: Mar. 5, 2015

(54) SOCIAL MEDIA INTEGRATION PLATFORM

(71) Applicant: Matthias Tebbe, Walldorf (DE)

(72) Inventor: Matthias Tebbe, Walldorf (DE)

(21) Appl. No.: 14/010,733

(22) Filed: Aug. 27, 2013

(51) Int. Cl. G06Q 50/00

(52) U.S. Cl. CPC G06Q 50/01
USPC 705/319

(57) ABSTRACT

Techniques for using a social media integration platform include receiving a request from a business system to interact with a social media system executing on a social media platform; integrating, using the social media integration platform, the request between the business system and the social media system by translating the request from the business system to a social media request compliant with the social media platform, wherein the social media integration platform is configured to translate requests between at least one type of business system and a plurality of different types of social media platforms; and sending the social media request to the social media system.

### TECHNICAL BACKGROUND

This disclosure relates to business software, more particularly, a social media integration platform for integration of social media system and business systems.

### BACKGROUND

Social media sites are becoming increasingly popular. Companies use social media to receive feedback from customers about products and services and to promote products. For example, a company can set up a home page on a social networking site where customers can post comments. As another example, a company can monitor public posts on a social networking site for posts mentioning the company's name, products, or services. As a further example companies may add an application to a social networking site to interact with customers directly, e.g., as in a product promotion game or questionnaire. Some social media systems and applications are very agile. Application Programming Interfaces (APIs) of social media platforms can change frequently and new platforms can rise in prominence quickly.

### SUMMARY

The present disclosure relates to computer-implemented methods, software, and systems for using a social media integration platform. In some implementations, techniques for using the social media integration platform include receiving a request from a business system to interact with a social media system executing on a social media platform; integrating, using the social media integration platform, the request between the business system and the social media system by translating the request from the business system to a social media request compliant with the social media platform, wherein the social media integration platform is configured to translate requests between at least one type of business system and a plurality of different types of social media platforms; and sending the social media request to the social media system.

Other general implementations include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

In a first aspect combinable with any of the general implementations, the techniques further comprise receiving a response to the social media request from the social media system; integrating, using the social media integration platform, the response between the business system and the social media system by translating the response to a business response compliant with the business system, wherein the social media integration platform is configured to translate requests between at least one social media platform and a plurality of different types of business systems; and sending the business response to the business system.

In a second aspect combinable with any of the previous aspects, the techniques further include updating the social media integration platform in response to an update of the social media platform so that the social media integration platform is configured to translate requests between the business system and the updated social media platform without requiring a business system update to the business system.

In a third aspect combinable with any of the previous aspects, the social media integration platform comprises a plurality of social media platform connectors each configured to provide an abstraction of a communication protocol and semantic layer for a respective social media platform.

In a fourth aspect combinable with any of the previous aspects, the social media integration platform comprises an identity management component configure to store and manage information for one or more social media users of the social media system.

In a fifth aspect combinable with any of the previous aspects, the social media integration platform comprises a plurality of business connectors each configured to provide an abstraction of a communication protocol and semantic layer for a respective business systems.

In a sixth aspect combinable with any of the previous aspects, the social media integration platform comprises a data staging engine configured to replicate data from the business system or the social media system or both to the social media integration system.

In a seventh aspect combinable with any of the previous aspects, the social media integration platform comprises a mapping engine configured to map data of the request from one data format to another format in compliance with a proprietary contract of the social media platform.

In an eighth aspect combinable with any of the previous aspects, the social media integration platform comprises an integration framework configured to perform an arbitrary number of steps according to an integration model in translating the request from the business system to the social media request compliant with the social media platform.

Various implementations of a computing system according to the present disclosure may have one or more of the following features. The social media integration platform can reduce the total cost of ownership (TCO) for integrating a business system with a social media system; the platform can provide capabilities to integrate a social media system into a heterogeneous business suite landscape; the platform can provide the capability to stage business system data to decouple from the business system; the protocol can manage social media users to access the social media platform on their behalf; and the platform can provide an abstract message format and protocol for a social media platform to allow homogenous access to common information categories of social media platforms.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system including a social media integration system;

FIG. 2 is a block diagram illustrating an example distributed computing system including an example social media integration system using a social media integration platform to integrate a social media system using a social media platform with a business system;

FIG. 3 is a flow chart of an example method for using a social media integration platform; and

FIG. 4 is a flow chart of an example method for updating a social media integration platform.

### DETAILED DESCRIPTION

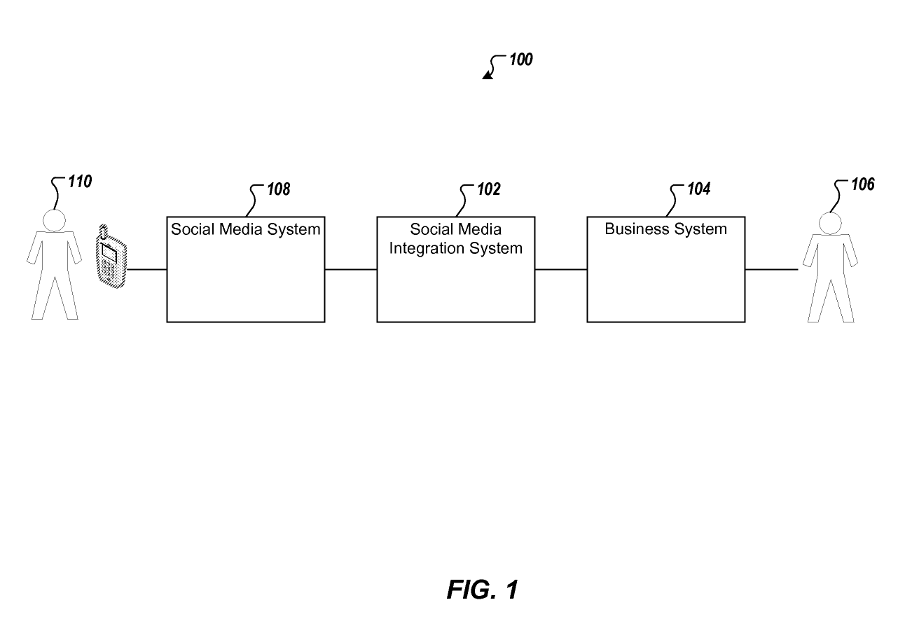

FIG. 1 is a block diagram illustrating an example distributed computing system 100 including a social media integration system 102. The illustrated example distributed computing system 100 includes a business system 104 and a social media system 108 that communicate across a network. At a high level, the business system and/or the social media system can be a server that is an electronic computing device operable to receive, transmit, process, store, or manage data and information associated with the example distributed computing system 100.

A business user 106 interacts with the business system 104, e.g., using a user device such as a personal computer. A social media user 110 interacts with the social media system 108, e.g., using a user device such as a mobile device. Multiple users can interact with each of the social media system and the business system.

The social media integration system 102 allows businesses to integrate their business systems with social media platforms in an agile—e.g., easily adapted—way with low total cost of ownership. The social media integration system 102 allows a bidirectional integration of a set of heterogeneous business systems to a set of defined social media platforms.

For example, the social media integration system 102 can use a social media integration platform to provide capabilities to connect social media platforms, manage social media users to access the social media platform on their behalf, and provide homogenous access to business system of common information categories (e.g., social media posts and comments) of social media platforms using abstract message formats and/or protocols of those social media platforms.

The social media integration system 102 can provide integration of the social media system 108 with the business system 104, for example, by providing capabilities to integrate one or more social media services into a heterogeneous business suite landscape, and by providing the capability to stage business system data to decouple from the business systems. The social media integration platform 102 can support message exchange between the business system and the social media system 108, e.g., using a mapping engine.

Some social media platforms operate in the cloud, e.g., as one or more servers providing social media services over a data communications network, e.g., the Internet. Hence, the social media integration system 102 can also operate in the cloud, which allows for system administrators of the social media integration system 102 to react to social media platform API changes in an agile and cost effective way.

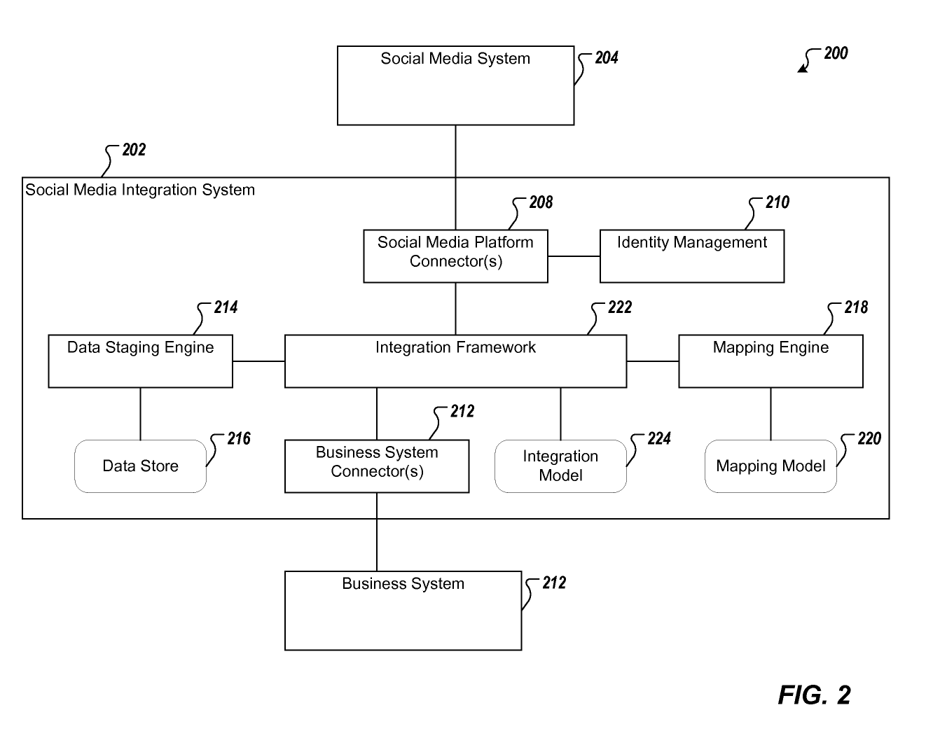

FIG. 2 is a block diagram illustrating an example distributed computing system 200 including an example social media integration system 202 using a social media integration platform to integrate a social media system 204 using a social media platform with a business system 212.

At a high level, the social media integration system 202 comprises one or more electronic computing devices operable to receive, transmit, process, store, or manage data and information associated with a social media integration platform. The social media integration platform can be configured to translate requests between at least one type of business system and a plurality of different types of social media platforms, and the social media integration platform can be configured to translate requests between at least one social media platform and a plurality of different types of business systems.

For example, the social media integration system can receive a request from the business system 212 to interact with the social media system 204. The social media system integrates, using the social media integration platform, the request between the business system and the social media system by translating the request from the business system to a social media request compliant with the social media platform and sends the social media request to the social media system. The social media integration system can then receive a response to the social media request from the social media system and integrate, using the social media integration platform, the response between the business system and the social media system by translating the response to business response compliant with the business system and send the business response to the business system.

As used in the present disclosure, the term “computer” is intended to encompass any suitable processing device. For example, the host system 100 can be implemented using one or more servers, as well as computers other than servers, including a server pool. In some examples, the host system 100 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the host system 100 may be adapted to execute any operating system, including Linux, UNIX, Windows, Mac OS, or any other suitable operating system.

Regardless of the particular implementation, “software” may include computer-readable instructions, firmware, wired or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, assembler, Perl, any suitable version of 4GL, as well as others. While portions of the software illustrated in FIG. 2 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The social media integration system 202 further includes a processor, and two or more processors may be used according to particular needs, desires, or particular implementations of the social media integration system. The processor may be a central processing unit (CPU), a blade, an application specific integrated circuit (ASIC), a field-programmable gate array (FPGA), or another suitable component. Generally, the processor executes instructions and manipulates data to perform the operations of the social media integration system.

The social media integration system 202 also includes a memory, and two or more memories may be used according to particular needs, desires, or particular implementations of the social media integration system 202. In some implementations, the memory can be external to the social media integration system 202. The memory may include any memory or database module and may take the form of volatile or non-volatile memory including, without limitation, magnetic media, optical media, random access memory (RAM), read-only memory (ROM), removable media, or any other suitable local or remote memory component. The memory may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the host system 100. Additionally, the memory may include any other appropriate data, such as VPN applications, firmware logs and policies, firewall policies, a security or access log, print or other reporting files, as well as others.

The social media integration system 202 includes one or more social media platform connectors 208. Because social media platforms have non standardized web APIs, the social media integration platform can be designed to access social media platforms in a homogeneous way to serve business systems and reduce the number of updates necessary at business systems in response to updates of social media platforms. A social media platform connector provides an abstraction of a communication protocol and semantic layer for a specific social media platform. The social media platform connector can provide social media platform specific APIs for artifacts that are specific to a particular social media platform.

The social media integration system 202 includes an identity management component 210. Some social media platforms allow a business system to access the social media system on behalf of a social media user, and the identity management component can store and manage information for the social media user, e.g., username and login credentials.

The social media integration system 202 includes one or more business system connectors 212. The business system can include one or more business modules, e.g., enterprise resource planning (ERP) systems, database systems, simple object access protocol (SOAP) servers, or other modules or systems. The social media integration system can include one business system connector per business system type to abstract a communication protocol level and semantic layer where appropriate. Communication between the social media integration system and the business system can be encrypted, e.g., by a virtual private network (VPN) tunnel.

The social media integration system 202 includes a data staging engine 214. Some business systems, or some networks, may not provide enough capacity to answer some requests from the social media system within a specified timeframe. To offload the business system's workload, the data staging engine allows replicating data from the business system to the social media integration system. The data staging engine stores that data in a data store 216. In some implementations, the data staging engine can stage information from the social media system, e.g., data that might be explicitly requests by a business system on demand or by a scheduled process.

The social media integration system 202 includes a mapping engine 218. In some examples, the data format that is used at the business system or the social media system follows a proprietary contract. The mapping engine 218 performs mapping data from one data format to another format in compliance with the proprietary contract. The mapping engine 218 can execute the mapping at any appropriate process step within the social media integration platform. The mapping engine 218 can use a mapping model 220, which may be a transformation such as an extensible stylesheet language transformation (XSLT) or another type of program code transformation.

The social media integration system 202 includes an integration framework 222. The integration framework 222 allows defining a sequence of process steps that can be executed in sequence or in parallel. In some examples, integrating business systems with social media systems requires an arbitrary set of steps, e.g., for various integration tasks. For example, the integration framework 222 can fulfill a business flow by performing various integrations between the business system and the social media system. The integration framework can perform a set of calls to the social media system or the business system. The integration framework can coordinate with multiple systems in fulfilling the business flow or one or more other integration flows.

The integration framework can use an integration model 224. The integration model 224 can be described using a domain specific language for integration models or by program code. In some implementations, the integration model combines information, e.g., update information, from an appropriate backend or social media system to access a certain set of business systems or social media systems.

The social media integration system can be deployed, e.g., on premise or as a hosted solution. In implementations using a hosted solution, the total cost of ownership may be lower. The social media integration system, as a centrally hosted system, can be kept up to date concerning social media platform APIs and system by the system administrator. For example, changes made by a social media platform may not cause any additional costs for the business using the social media integration system in many cases, because the social media platform can be adapted to handle the changes.

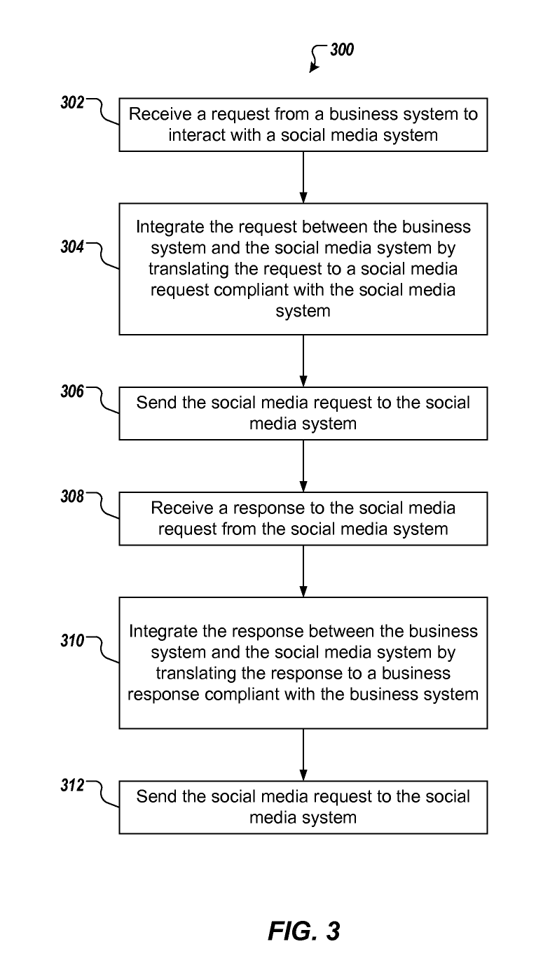

FIG. 3 is a flow chart 300 of an example method for using a social media integration platform. For clarity of presentation, the description that follows generally describes method 300 in the context of FIG. 1. However, method 300 may be performed, for example, by any other suitable system, environment, software, and hardware, or a combination of systems, environments, software, and hardware as appropriate.

A request is received from a business system to interact with a social media system executing on a social media platform (302). The request is integrated, using the social media integration platform, between the business system and the social media system by translating the request from the business system to a social media request compliant with the social media platform (304). The social media integration platform is configured to translate requests between at least one type of business system and a plurality of different types of social media platforms. Integrating the request can include an arbitrary number of parallel and/or sequential steps, depending on the type of request and the social media platform API.

The social media request is sent to the social media system (306). In some examples, a response to the social media request is received from the social media system (308). The response is integrated, using the social media integration platform, between the business system and the social media system by translating the response to a business response compliant with the business system (310). The social media integration platform can be configured to translate requests between at least one social media platform and a plurality of different types of business systems. The business response is sent to the business system (312).

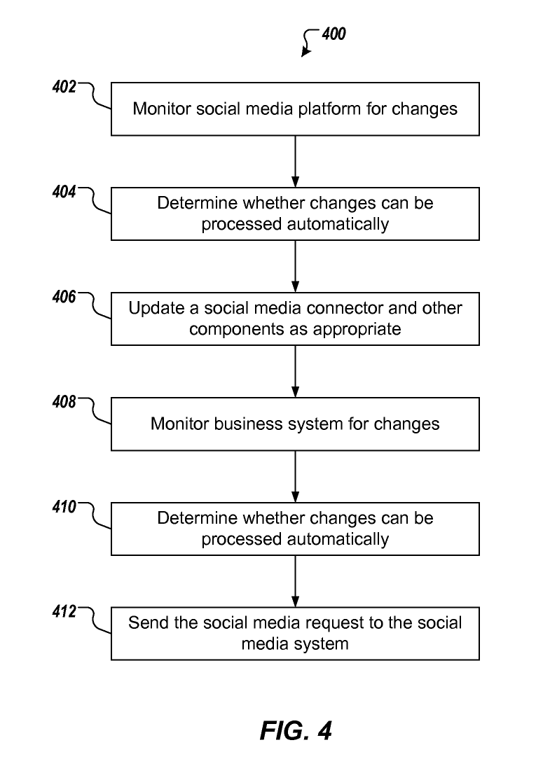

FIG. 4 is a flow chart 400 of an example method for updating a social media integration platform. For clarity of presentation, the description that follows generally describes method 300 in the context of FIG. 1. However, method 400 may be performed, for example, by any other suitable system, environment, software, and hardware, or a combination of systems, environments, software, and hardware as appropriate.

A social media platform is monitored for changes (402). For example, a server publishing an API for the social media platform can be queried at periodic intervals. Upon identifying a change, the change is analyzed to determine whether the changes can be processed automatically, without system administrator supervision, or whether input from a system administrator is appropriate (404). If appropriate, the system administrator is notified, e.g., by email. A respective social media connector for the social media platform is then updated to reflect the change in the social media platform (406). In some examples, it may be appropriate to update other components of the social media integration platform.

A business system is monitored for changes (408). For example, a web interface can be made available for a business system user to notify the social media integration platform of changes. Upon identifying a change, the change is analyzed to determine whether the changes can be processed automatically, without system administrator supervision, or whether input from a system administrator is appropriate (410). If appropriate, the system administrator is notified, e.g., by email. A respective business connector for the business system is then updated to reflect the change in the business system. In some examples, it may be appropriate to update other components of the social media integration platform.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, e.g., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method of using a social media integration platform, the method comprising:
receiving a request from a business system to interact with a social media system executing on a social media platform;
integrating, using the social media integration platform, the request between the business system and the social media system by translating the request from the business system to a social media request compliant with the social media platform, wherein the social media integration platform is configured to translate requests between at least one type of business system and a plurality of different types of social media platforms; and
sending the social media request to the social media system.

2. The method of claim 1, further comprising:
receiving a response to the social media request from the social media system;
integrating, using the social media integration platform, the response between the business system and the social media system by translating the response to a business response compliant with the business system, wherein the social media integration platform is configured to translate requests between at least one social media platform and a plurality of different types of business systems; and
sending the business response to the business system.

3. The method of claim 1, further comprising updating the social media integration platform in response to an update of the social media platform so that the social media integration platform is configured to translate requests between the business system and the updated social media platform without requiring a business system update to the business system.

4. The method of claim 1, wherein the social media integration platform comprises a plurality of social media platform connectors each configured to provide an abstraction of a communication protocol and semantic layer for a respective social media platform.

5. The method of claim 1, wherein the social media integration platform comprises an identity management component configure to store and manage information for one or more social media users of the social media system.

6. The method of claim 1, wherein the social media integration platform comprises a plurality of business connectors each configured to provide an abstraction of a communication protocol and semantic layer for a respective business systems.

7. The method of claim 1, wherein the social media integration platform comprises a data staging engine configured to replicate data from the business system or the social media system or both to the social media integration system.

8. The method of claim 1, wherein the social media integration platform comprises a mapping engine configured to map data of the request from one data format to another format in compliance with a proprietary contract of the social media platform.

9. The method of claim 1, wherein the social media integration platform comprises an integration framework configured to perform an arbitrary number of steps according to an integration model in translating the request from the business system to the social media request compliant with the social media platform.

10. A non-transitory computer storage medium encoded with a computer program, the program comprising instructions that when executed by one or more computers cause the one or more computers to perform operations comprising:
receiving a request from a business system to interact with a social media system executing on a social media platform;
integrating, using the social media integration platform, the request between the business system and the social media system by translating the request from the business system to a social media request compliant with the social media platform, wherein the social media integration platform is configured to translate requests between at least one type of business system and a plurality of different types of social media platforms; and
sending the social media request to the social media system.

11. The computer storage medium of claim 10, the operations further comprising:
receiving a response to the social media request from the social media system;
integrating, using the social media integration platform, the response between the business system and the social media system by translating the response to a business response compliant with the business system, wherein the social media integration platform is configured to translate requests between at least one social media platform and a plurality of different types of business systems; and
sending the business response to the business system.

12. The computer storage medium of claim 10, the operations further comprising updating the social media integration platform in response to an update of the social media platform so that the social media integration platform is configured to translate requests between the business system and the updated social media platform without requiring a business system update to the business system.

13. The computer storage medium of claim 10, wherein the social media integration platform comprises a plurality of social media platform connectors each configured to provide an abstraction of a communication protocol and semantic layer for a respective social media platform.

14. The computer storage medium of claim 10, wherein the social media integration platform comprises an identity management component configure to store and manage information for one or more social media users of the social media system.

15. The computer storage medium of claim 10, wherein the social media integration platform comprises a plurality of business connectors each configured to provide an abstraction of a communication protocol and semantic layer for a respective business systems.

16. The computer storage medium of claim 10, wherein the social media integration platform comprises a data staging engine configured to replicate data from the business system or the social media system or both to the social media integration system.

17. The computer storage medium of claim 10, wherein the social media integration platform comprises a mapping engine configured to map data of the request from one data format to another format in compliance with a proprietary contract of the social media platform.

18. The computer storage medium of claim 10, wherein the social media integration platform comprises an integration framework configured to perform an arbitrary number of steps according to an integration model in translating the request from the business system to the social media request compliant with the social media platform.

19. A system of one or more computers configured to perform operations comprising:
receiving a request from a business system to interact with a social media system executing on a social media platform;
integrating, using the social media integration platform, the request between the business system and the social media system by translating the request from the business system to a social media request compliant with the social media platform, wherein the social media integration platform is configured to translate requests between at least one type of business system and a plurality of different types of social media platforms; and
sending the social media request to the social media system.

20. The system of claim 19, the operations further comprising:
receiving a response to the social media request from the social media system;
integrating, using the social media integration platform, the response between the business system and the social media system by translating the response to a business response compliant with the business system, wherein the social media integration platform is configured to translate requests between at least one social media platform and a plurality of different types of business systems; and
sending the business response to the business system.
